(19) United States
(12) Patent Application Publication
(10) Pub. No.: US 2020/0143236 A1
(43) Pub. Date: May 7, 2020

(54) Method, System, and Computer Program Product for Data Pre-Processing in Deep Learning

(71) Applicant: Stephen D. Liang, Irving, TX (US)

(72) Inventor: Stephen D. Liang, Irving, TX (US)

(21) Appl. No.: 16/179,955

(22) Filed: Nov. 4, 2018

(51) Int. Cl. G06N 3/08; G06N 3/04; G06K 9/62; G06F 17/16

(52) U.S. Cl. CPC G06N 3/08; G06F 17/16; G06K 9/6256; G06N 3/0472

(57) ABSTRACT

The goal of this invention is to develop smart and fast data processing scheme for more computational efficient deep learning to support adaptive and real-time applications. We propose to apply Singular-Value Decomposition (SVD)-QR algorithm to preprocessing of deep learning for large scale data input. For the mass data input, we apply Limited Memory Subspace Optimization for SVD (LMSVD)-QR algorithm to increase the data processing speed. Simulation results in automated handwritten digit recognition show that SVD-QR and LMSVD-QR can tremendously reduce the number of input to deep learning neural network without losing its performance, and both can tremendously increase the data processing speed for deep learning.

### BACKGROUND OF THE INVENTION

### Field of the Invention

The field of this invention is in data pre-processing for deep learning of neural networks. more particularly to a method, system, and computer program product for deep learning. In other words, the basic types of things that the invention improves or is implemented relates to make the input data to neural networks much less and efficient, and uses less data to achieve the same performance as that of more data.

### Discussion of the Background

Recent advances of deep learning such as AlphaGo Zero and Master, Google Self-Driving Car, ImageNet/AlexNet, Microsoft Translator, have produced encouraging results comparable to and in some cases superior to human experts. For example, AlexNet was able to classify 15M labeled high resolution images to roughly 22K categories [ [symbol] ]. AlexNet consists of variable-resolution images, while the deep learning system requires a constant input dimensionality. The approach from AlexNet down-sampled the images to a fixed resolution of 227×227×3 [ [symbol] ]. For a rectangular image, they first resealed the image to make the shorter side of length 227, and then cropped out the central 227×227×3 patch from the resulting image. This is a really large-scale input to the convolutional neural networks (CNN).

There could be many possible data pre-processing schemes for deep learning, which can be divided into two categories.
1. Data are reduced via keeping a subset, and their original features are kept. A simple method is down-sampling by N, which keeps one sample for every N samples uniformly. Recent advances in non-uniform samplers such as co-prime samplers [ [symbol] ][ [symbol] ] could be applied to smart and fast data processing in deep learning. Co-prime samplers are based on the the assumption that the input data are identical and independent distribution (i.i.d.) and the autocorrelation of the co-prime sampled data still have the same 2nd-order statistics. This could be used to dynamically reduce the number of input to deep learning neural networks via adjusting the down-sampling parameters in co-prime samplers. The features of the original data are still kept, for example, mean, standard deviation, and some visual features.
2. Data are transformed, and original features are lost. For example, compressed sensing is a method to tremendously reduce the original data set [ [symbol] ][ [symbol] ]. In the compression part, it employs a transformation via measurement matrix; and in the decompression part, it tries to recover the original the signal (with certain distortion) using an optimization process [ [symbol] ]. This signal reconstruction method is very successful with few measurements, which leads to signal acquisition methods that effect compression as part of the measurement process (hence “compressed sensing”). These realizations via exploiting signal sparsity have spawned an explosion of research yielding exciting results in a wide range of topics, encompassing algorithms, theory, and applications [ [symbol] ][ [symbol] ]. However, the features of the original data are not kept, and the statistics and visual features of the reduced data set are lost in the compression part.

In this invention, we are interested in combining the advantages of the above two categories, namely, to keep the physical features of the original data, but use linear transformation in the data subset selection process. We try to target two scenarios, large scale data set and mass data set. For large scale data set, we propose to use SVD-QR for the data subset selection, where SVD is used to sort the singular values and corresponding singular vectors, and the size of the data subset could be determined based on singular values; and QR is used to select which data samples should be selected as input for deep learning. The SVD is a linear transformation, however the QR helps to determine the data index of data subset to be selected, which makes the selected data subset same features as the original data set. For deep learning with massive data input (say matrix with size of thousands times thousands), how to extend the SVD-QR method to massive data systems? A major challenge in massive data processing is to extend the existing works on single machine and medium or large size data preprocessing, especially considering real-world systems and architectural constraints [ [symbol] ].

### U.S. Patent Documents

The following U.S. patents are on data processing. but most of them are not related to deep learning. U.S. Pat. Nos. 6,243,490 and 5,719,955 are on data processing using neural networks having conversion tables in an intermediate layer, but not on the data pre-processing for the input of neural network (in this invention).

1. U.S. Pat. No. 10,117,001 Data processing device and data processing method

2. U.S. Pat. No. 10,116,442 Data storage apparatus, data updating system, data processing method, and computer readable medium

3. U.S. Pat. No. 10,116,335 Data processing method, memory storage device and memory control circuit unit

4. U.S. Pat. No. 10,115,222 Data processing systems

5. U.S. Pat. No. 10,111,608 Method and apparatus for providing data processing and control in medical communication system

6. U.S. Pat. No. 10,110,341 Data processing method, precoding method, and communication device

7. U.S. Pat. No. 10,108,921 Customs inspection and data processing system and method thereof for web-based processing of customs information

8. U.S. Pat. No. 10,108,844 Methods and systems for image data processing

9. U.S. Pat. No. 10,108,820 Snapshot data and hibernation data processing methods and devices

10. U.S. Pat. No. 10,108,467 Data processing system with speculative fetching

11. U.S. Pat. No. 10,108,296 Method and apparatus for data processing method

12. U.S. Pat. No. 10,104,142 Data processing device, data processing method, program, recording medium, and data processing system

13. U.S. Pat. No. 10,104,122 Verified sensor data processing

14. U.S. Pat. No. 10,102,167 Data processing circuit and data processing method

15. U.S. Pat. No. 10,102,066 Data processing device and operating method thereof

16. U.S. Pat. No. 10,097,868 Data processing device and data processing method

17. U.S. Pat. No. 10,097,758 Data processing apparatus, data processing method, and recording medium

18. U.S. Pat. No. 10,097,595 Data processing method in stream computing system, control node, and stream computing system

19. U.S. Pat. No. 10,097,343 Data processing apparatus and data processing method

20. U.S. Pat. No. 10,096,452 Data processing method, charged particle beam writing method, and charged particle beam writing apparatus

21. U.S. Pat. No. 10,095,613 Storage device and data processing method thereof

22. U.S. Pat. No. 6,243,490 Data processing using neural networks having conversion tables in an intermediate layer

23. U.S. Pat. No. 5,719,955 Data processing using neural networks having conversion tables in an intermediate layer

### BRIEF SUMMARY OF THE INVENTION

The above and other needs are addressed by the present invention, which provides smart and fast data pre-processing for deep learning in two scenarios: large-scale data input and mass data input.

Accordingly, one practical approach of SVD-QR is applied to large-scale data input for deep learning. The SVD is able to find the maximum singular values, and QR helps to identify which columns are corresponding to these singular values. The other approach is LMSVD-QR for mass data input for deep learning.

Still other aspects, features, and advantages of the present invention are readily apparent from the following detailed description, simply by illustrating using handwritten digits recognition. The present invention is also capable of other applications with large scale data input or mass data input for deep learning in neural networks.

### BRIEF DESCRIPTION OF THE SEVERAL VIEWS OF THE DRAWING

The present invention is illustrated by way of example, and not by way of limitation, in the figures of the accompanying drawings and in which like reference numerals refer to similar elements and in which:

FIG. 1 is an example illustrating 25 pictures of handwritten digits in the data set.

FIG. 2(a)(b) are graphs illustrating the probability of recognition accuracy of SVD-QR preprocessing and uniform downsampling. (a) Neural network-based approach, (b) linear classifier approach.

FIG. 3 are graphs of probability of recognition accuracy of SVD-QR preprocessing in Neural network-based approach with different α values.

FIG. 4(a)(b) are graphs illustrating running time versus the number of inputs. (a) Neural network-based approach, (b) linear classifier approach.

FIG. 5 is a graph illustrating probability of recognition accuracy of LMSVD-QR preprocessing for neural network.

FIG. 6 are graphs illustrating the number of input versus the percentage of kept singular values.

FIG. 7 are graphs illustrating running time versus the number of inputs based on LMSVD-QR in neural network-based approach.

FIG. 8(a)(b) are pictures illustrating handwritten digits after SVD-QR, (a) with only 32 pixels left, and (b) with 70 pixels left.

FIG. 9(a)(b) are pictures illustrating handwritten digits after uniform downsampling, (a) with 37 pixels left; and (b) with 100 pixels left.

FIG. 10 (a)(b) are pictures illustrating handwritten digits after LMSVD-QR pre-processing with r=300. (a) with only 32 pixels left when λ=0.5; (b) with 69 pixels left when λ=0.7.

FIG. 11(a)(b) are pictures illustrating the selected columns of matrix (i.e., the pixel index). (a) λ=0.5; (b) λ=0.7.

### DETAILED DESCRIPTION OF THE INVENTION

### Smart and Fast Data Processing for Deep Learning with Large Scale Data Input

We propose to apply SVD-QR for pre-processing for deep learning. For deep learning applications with 1-D input, we can construct a matrix Ψ based on its multiple input from training set. The pre-processing procedure can be summarized as follows.
1. Calculate the SVD [ [symbol] ] of Ψ as

$$Ψ = U [ \begin{matrix}Σ & 0 \\ 0 & 0\end{matrix} ] {V}^{T}$$

and save V.
2. Based on the diagonal values of Σ, σ₁, σ₂, . . . , σᵣ (r=rank(Ψ)) and desired percentage of kept singular values λ, to determine \hat{r}, (\hat{r}≤r), where

$$λ = \frac{{\sum }_{i = 1}^{\hat{r}} {σ}_{i}}{{\sum }_{i = 1}^{r} {σ}_{i}} .$$

λ stands for the percentage of the kept input power, and when λ=100%, there is no input reduction.
3. Partition

$$V = [ \begin{matrix}{V}_{11} & {V}_{12} \\ {V}_{21} & {V}_{22}\end{matrix} ] ,$$

where V₁₁∈ [symbol] ^{\hat{r}-\hat{r}}, V₁₂∈ [symbol] ^{\hat{r}×(M-\hat{r})}, V₂₁∈ [symbol] ^{(M-\hat{r})×\hat{r}×}, and V₂₂∈ [symbol] ^{(M-\hat{r})×(M-\hat{r})}.
4. Using QR decomposition with column pivoting, determine π such that

Q^{T}[V₁₁^{T},V₂₁^{T}]π=[R₁₁,R₁₂] (1)
where Q is a unitary matrix.
5. The permutation matrix π corresponds to the ordered most-significant singular values based on the position of 1's in each column, and we can choose the first \hat{r} columns. The row positions of 1's in the \hat{r} columns will enable us to find the \hat{r} most significant columns in Ψ, which are the \hat{r} most important input to the deep learning networks.

### Preprocessing for Mass Data Input

We shall apply Limited Memory Subspace Optimization for SVD (LMSVD) algorithm [ [symbol] ] to deep learning preprocessing with massive data input. LMSVD is used for computing dominant singular value decompositions of large matrices. The approach is based on a block Krylov subspace optimization technique which significantly accelerates the classic simultaneous iteration method, then QR could be applied following the LMSVD to obtain the \hat{r} most important columns in Ψ. The purpose of LMSVD is to to compute dominant SVDs of mass data in matrices, with desired precision via choosing appropriate k value, i.e., to consider a real matrix Ψ∈ [symbol] ^{m×n} and a given positive integer k<<min(m, n), such that [ [symbol] ]

$$Ψ \approx {Ψ}_{k} = {U}_{k} {Σ}_{k} {V}_{k}^{T} = arg {min}_{rank ( W ) < k} {‖ Ψ - W ‖}_{F}^{2} \qquad ( 2 )$$

where ∥⋅∥ denotes the Frobenius norm of matrix, and Uₖ∈ [symbol] ^{m×k}, Vₖ∈ [symbol] ^{n×k}, a diagonal matrix Σₖ∈ [symbol] ^{k×k} whose entries σ₁≥σ₂≥ . . . ≥σₖ are the k largest singular values of Ψ. So the approximation factor k value is critical in determining the accuracy of this approximation.

The main theoretical basis for LMSVD is that the k leading eigenvectors of ΨΨ^{T} maximize the following Rayleigh-Ritz function under orthogonality constraint:

$${max}_{Ψ ∈ {ℛ}^{m \times k}} {‖ {Ψ}^{T} X ‖}_{F}^{2} \qquad ( 3 )$$

subject to X^{T}X=I. The goal of LMSVD is to compute the kth dominant SVD of a matrix Ψ∈R^{m×n} as defined in (2) based on accelerating the simple subspace iteration (SSI) method via solving (3) in a chosen subspace at each iteration [ [symbol] ]. Based on LMSVD, we are able to obtain Uₖ, Σₖ Vₖ. We propose to use LMSVD-QR on the basis of LMSVD results to select the desired inputs for deep learning.

Based on the diagonal values of Σₖ, σ₁, σ₂, . . . , σₖ and desired percentage of kept singular values λ, to determine \hat{r}, (\hat{r}<<k), where

$$λ = \frac{{\sum }_{i = 1}^{\hat{r}} {σ}_{i}}{{\sum }_{i = 1}^{r} {σ}_{i}} .$$

Similarly we can partition Vₖ, and use the same procedure as in Section 7 to determine the \hat{r} most important inputs to the deep learning networks.

### Simulation Results for SVD-QR Approach

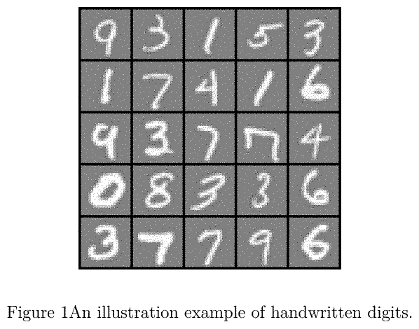

In this invention, handwritten digits recognition is used in our simulation. We apply SVD-QR pre-processing and LMSVD-QR pre-processing for deep learning neural networks to handwritten digits (from 0 to 9) recognition, as illustrated in FIG. 1. Handwritten alphabets recognition will be studied in our future works.

Our simulation was based on data set in ex3data1.mat in www.coursera.org (Machine Learning) [ [symbol] ] that contains 5000 training examples of handwritten digits. Each training/testing example contains a 20×20 pixels grayscale image of the digit from 0 to 9, and each pixel is represented by a floating point number (from −0.1320 to 1.1277 in the data set we used) indicating the grayscale intensity at that location. The 20×20 grid of pixels can be vectorized into a 400-dimensional vector. So a matrix can be constructed where each of these training examples becomes a single row. This gives us a 5000×400 matrix where every row is a training example for a handwritten digit (0 to 9) image. The second part of the training set is a 5000-dimensional vector that contains labels (actual digit from 0 to 9) for the training set. Totally we have 5000 examples of handwritten digits in the database, and each digit (from 0 to 9) has 500 examples.

A feedforward neural network (NN) [ [symbol] ] was applied to this application with three layers. The input layer has 400 units because 20×20 pixels (matrix 20×20) could be vectorized into a vector with length 400. The hidden layer has 25 units, and output layer has 10 units (to represent the 10 digits from 0-9). The feedforward neural network was trained using steepest descent algorithm. We trained neural networks using backpropagation to compute the gradient for the neural network cost function. For regularized logistic regression, the cost function is defined as [ [symbol] ]

$$J ( θ ) = \frac{1}{m} {\sum }_{i = 1}^{m} {\sum }_{k = 1}^{K} [ - {y}_{k}^{( i )} log ( {( {h}_{θ} ( {x}^{( i )} ) )}_{k} ) - ( 1 - {y}_{k}^{( i )} ) {log ( 1 - {h}_{θ} ( {x}^{( i )} ) )}_{k} ) ] + \frac{α}{2 m} [ {\sum }_{j = 1}^{25} {\sum }_{k = 1}^{400} {( {Θ}_{j , k}^{( 1 )} )}^{2} + {\sum }_{j = 1}^{10} {\sum }_{k = 1}^{25} {( {Θ}_{j , k}^{( 2 )} )}^{2} ] \qquad ( 4 )$$

where m is the input data length, and K=10 is the total number of labels (from 0 to 9). h_{θ}(χ⁽ⁱ⁾)ₖ=is the activation output of the k-th unit in the output layer. We randomly initialized the parameters Θ^{(l)} for symmetry breaking. The initial value range is chosen based on

$$\frac{\sqrt{6}}{\sqrt{{L}_{in} + {L}_{out}}}$$

[ [symbol] ] where Lᵢₙ and Lₒᵤₜ are the number of units in the layers adjacent to Θ^{(l)}, so we chose Θ8^{(l)} uniformly distributed within [−0.12, 0.12]. We chose α=0.1 since it could get better performance based on our experience, and we also compared it against other values of α.

In comparison, we also applied linear classifier (logistic regression model) [ [symbol] ] to this application. We use multiple one-vs-all logistic regression models to build a multi-class classifier. Since there are 10 classes, we need to train 10 separate logistic regression classifiers. For regularized logistic regression, the cost function is defined as [ [symbol] ]

$$J ( θ ) = \frac{1}{m} {\sum }_{i = 1}^{m} [ - {y}^{( i )} log ( {h}_{θ} ( {x}^{( i )} ) ) - ( 1 - {y}^{( i )} ) log ( 1 - {h}_{θ} ( {x}^{( i )} ) ) ] + \frac{α}{2 m} {\sum }_{j = 1}^{n} {θ}_{j}^{2} \qquad ( 5 )$$

where m is the input data length, and for every example i, we compute h_{θ}(χ⁽ⁱ⁾)=g(θ^{T}χ⁽ⁱ⁾) and

$$g ( x ) = \frac{1}{1 + {e}^{- x}}$$

is the sigmoid function. Steepest descent was used to train the parameters in the logistic regression model, and we chose α=0.1 since it could get better performance.

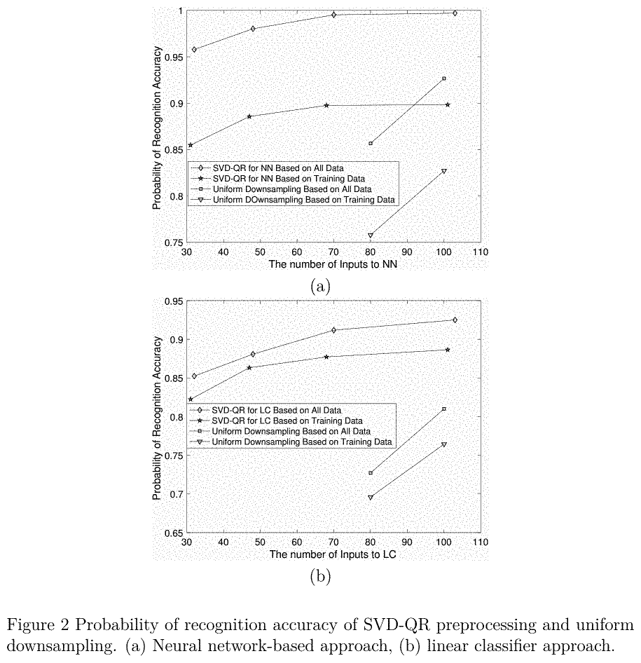

We ran simulations for two scenarios.
1. In the first scenario, all data (5000 examples) were used in training for 200 iterations, and then parameters in the feedforward neural network were frozen, and the 5000 examples were tested for recognition accuracy. The probability of recognition accuracy is 99.7%. In contrast, we applied the SVD-QR preprocessing to a feedforward network with the same number of neurons in hidden layer and output. For all 5000 examples (each example is a vector with length 400), we can get a matrix Φ with size 5000×400. Based on the procedure described above, we chose \hat{r} which satisfies that the ratio between the sum of \hat{r} largest singular values and the sum of all singular values is greater λ. We chose λ=0.5, 0.6, 0.7, 0.8, and the corresponding \hat{r}=32, 48, 70,103, respectively. In comparison, we applied uniform downsampling with 80 and 100 columns kept in Φ. In FIG. 2a, the probability of recognition accuracy of SVD-QR preprocessing and uniform downsampling based on all data (5000 samples) are plotted. Observe that SVD-QR preprocessing performs very well, and for 103 inputs, the probability of recognition accuracy (99.7%) is the same as that of 400 inputs (99.7%), and it performs much better than that of uniform downsampling (92.66% for 100 inputs).

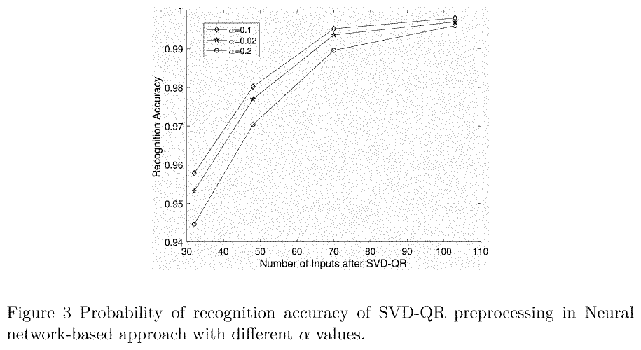

All these simulations were based on α=0.1. To see how other a values work, we also compared it against other values of α, as summarized in FIG. 3. Observe that α=0.1 performs the best, so we chose α=0.1 in all remaining simulations.

In this scenario, the linear classifiers were also trained for 200 iterations based on all 5000 examples. For linear classifier with 400 inputs, the probability of recognition accuracy is 96.36%. We applied SVD-QR for preprocessing, and the performances are summarized in FIG. 2b for different number of inputs. Observe that for 103 inputs after SVD-QR, the probability of recognition accuracy is 92.5%, and for 100 inputs after uniform downsampling, the performance is only 81%, which shows SVD-QR preprocessing performs much better than uniform downsampling. Comparing neural network classifier to linear classifier, it's clear that neural network-based approach performs much better. Our simulation results also demonstrate that SVD-QR preprocessing is very powerful for neural network-based deep learning.
2. In the second scenario, only 50% of the data (2500 examples, 250 examples for each digit) were used in training for 200 iterations, and then parameters in the deep feedforward network were frozen, and the remaining 2500 examples (250 examples for each digit) were tested for recognition accuracy. The probability of recognition accuracy is 90.2%. In contrast, we applied the SVD-QR preprocessing to a deep feedforward neural network with three layers. For the training set 2500 examples (each example is a vector with length 400), we can get a matrix Φ with size 2500×400. Similarly, we chose λ=0.5, 0.6, 0.7, 0.8, and the corresponding \hat{r}=31, 47, 68, 101, respectively. In comparison, we also applied uniform downsampling with 80 and 100 columns kept in Φ. The probability of recognition accuracy of SVD-QR preprocessing and uniform downsampling based on 2500 examples for training and 2500 examples for testing are summarized in FIG. 2a (for neural network-based approaches) and FIG. 2b (for linear classifier-based approach).

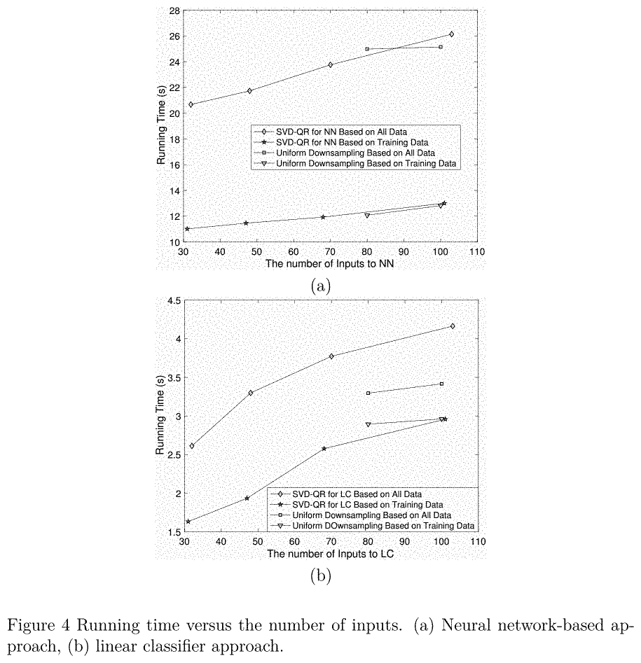

Observe the two sets of comparisons in FIG. 2a, the SVD-QR preprocessing tremendously reduces the number of inputs to neural networks. Based on 103 inputs (after SVD-QR, for all data training), the NN performs exactly the same as that of 400 inputs (99.7%). For the second scenario, 101 inputs (after SVD-QR preprocessing) can achieve recognition accuracy 89.84% comparing to accuracy of 90.2% with 400 inputs. Most important, the smaller number of inputs reduces the computational complexity and increases the speed of decision process. To compare the running time numerically, we ran the simulations for neural network-based approach with original 400 inputs, and the simulation time is 75 seconds based on MacBook Pro with 2.8 GHz Intel Core i7 Processor and 16 GB memory. For comparison with SVD-QR preprocessing, the running time versus the number of inputs are summarized for both neural network-based approach (in FIG. 4a) and linear classifier (in FIG. 4b). The energy consumption is proportional to the running time, so comparing to the original 400 inputs, SVD-QR approach has reduced the energy consumption around 70%, which is good for energy efficient IoT.

### Simulation Results for LMSVD-QR Approach

As presented in Section 8, the approximation factor k value is critical in determining the accuracy of LMSVD approximation, and subsequently λ will help to determine the number of input \hat{r} to deep learning network. We ran simulations for different k values (k=200, 250, 300) and λ values (λ=0.5, 0.6, 0.7, 0.8).

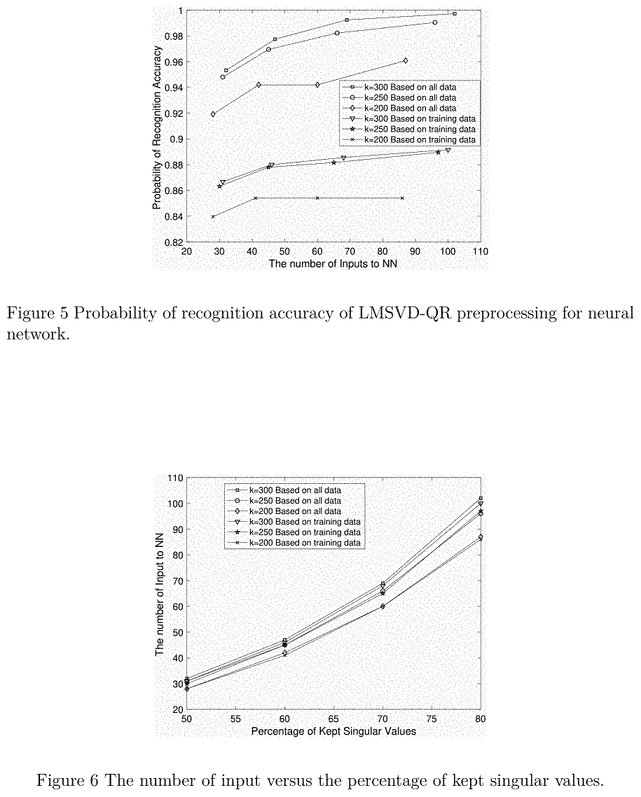

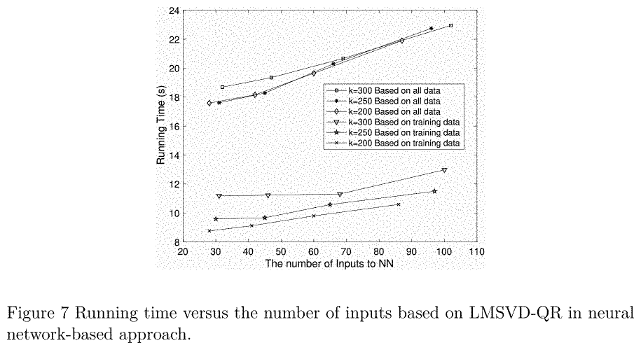

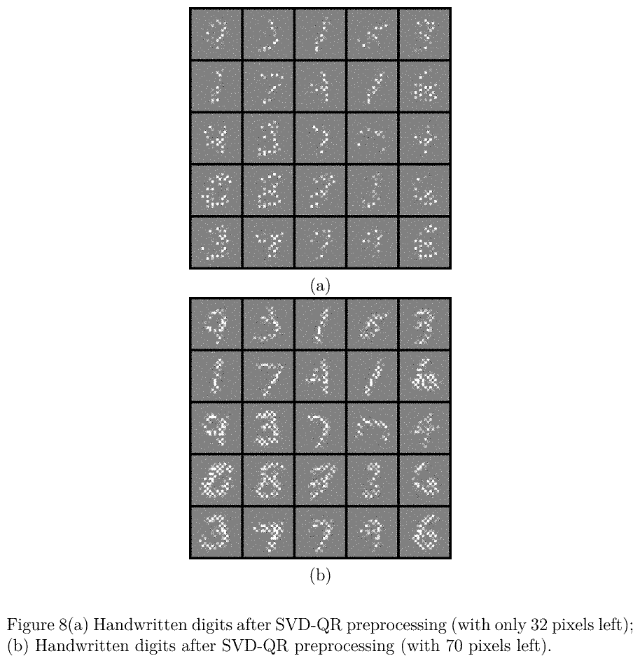

Similar to the two scenarios in Section 11, we also ran simulations for the same two scenarios, i.e., all data (5000 examples) were used in training for 200 iterations, versus only 50% data were used in training for 200 iterations. We summarize the probability of recognition accuracy of LMSVD-QR preprocessing for neural network in FIG. 5, the number of input versus the percentage of kept singular values (λ) in FIG. 6, and running time versus the number of inputs in FIG. 7.

Observe FIGS. 5-7, the performances of neural network in scenario one (based on all data for training) are much better than those in scenario two (based on 50% data in training and remaining 50% for testing). Observe FIG. 5, for k=300 with all data in training, the probability of recognition accuracy is 99.7% with only 104 inputs, same as that with the number of inputs 400 (with no input reduction); and for both scenarios, the probability of recognition accuracy with k=300 performs much better than k=250 and k=200, which verifies that large value of k has better approximation in LMSVD. Observe FIG. 6, the number of input monotonically increases when the percentage of kept singular values (λ) increases, and the value of k or training scenario doesn't have big impact on the number of inputs. However, even for the same λ, different k results in different \hat{r} because k value determines the approximation accuracy in (2), and different singular values and singular vectors are obtained for different k.

Regarding the deep learning processing speed, it is vastly increased because of LMSVD-QR. As mentioned in Section 11, for no input reduction (with the number of input 400), the running time is 75 seconds. Observe FIG. 7, the running time of has been vastly reduced because of smart and fast preprocessing using LMSVD-QR. For example, with k=300, and the number of input reduced to 104, it only takes 23 seconds to achieve the same recognition accuracy with 400 inputs. Comparing to the original 400 inputs, LMSVD-QR approach has reduced the energy consumption around 75%, which is more desirable for energy efficient IoT.

### Performance Analysis

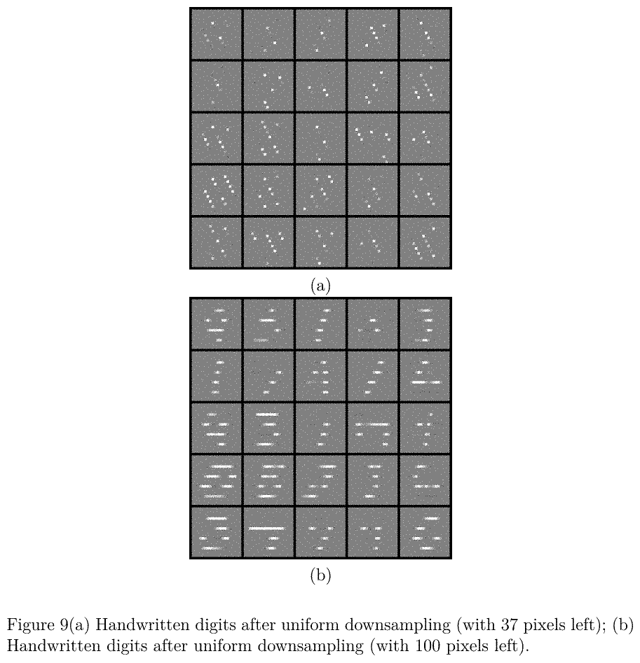

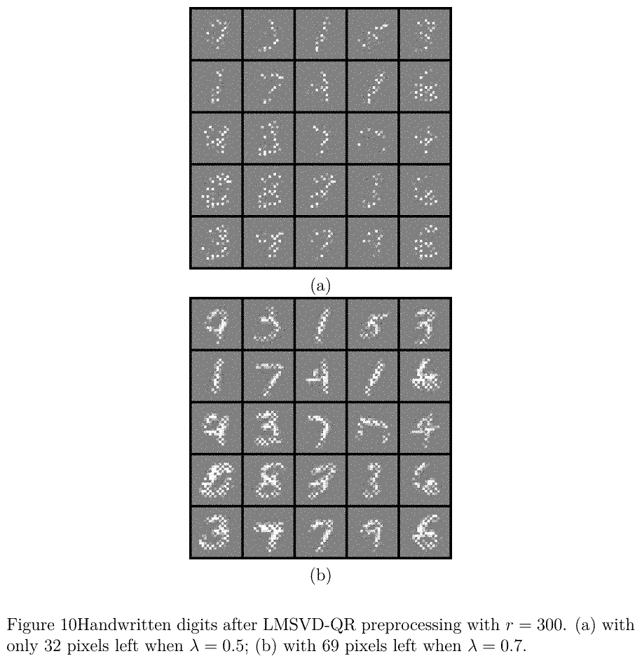

How did the SVD-QR and LMSVD-QR algorithms improve real-time preprocessing? The SVD-QR and LMSVD-QR selected only a small subset as input to neural network for deep learning. Observe (4), m, is the input data length. When m is smaller because of data pre-processing, much less number of computations will be involved, which improves deep learning speed. Since SVD-QR and LMSVD-QR are linear transformations, their computation speeds are very fast, so the data preprocessing time could be negligible comparing to the deep learning iterative process. Why did the SVD-QR preprocessing performs much better than uniform downsampling? To examine it visually, the handwritten digits after SVD-QR preprocessing were illustrated in FIG. 8a (with only 32 pixels left) and FIG. 8b (with 70 pixels left) based on 25 digits examples. Since only partial pixels were left, we filled in the reduced pixels using 0's to make the visual effects comparable to the original images in FIG. 1. Based on FIG. 2a, the probability of recognition accuracy for neural network and SVD-QR preprocessing-based approach is 95.87% for 32 pixels, and 99.52% for 70 pixels. We compared it against uniform downsampling, and same handwritten digits after uniform downsampling were illustrated in FIG. 9a (downsampling by 11, with 37 pixels left) and In FIG. 9b (downsampling by 4, with 100 pixels left). Based on FIG. 2a, the probability of recognition accuracy for neural network and uniform downsampling-based approach is 92.66% for 100 pixels. We ran simulations for uniform downsampling by 11 (with 37 pixels left), and obtained the probability of recognition accuracy 81.2%. Our visual observation of FIG. 8ab also testifies that they are easy to be identified after SVD-QR preprocessing, but FIG. 9ab are much more difficult to be identified.

For the LMSVD-QR preprocessing algorithm, we also illustrated it when we chose r=300 in FIG. 10a (with only 32 pixels left) and FIG. 10b (with 69 pixels left) based on the same 25 digits examples. Based on FIG. 2a, the probability of recognition accuracy for LMSVD-QR preprocessing-based neural network approach is 95.32% for 32 pixels, and 99.24% for 69 pixels.

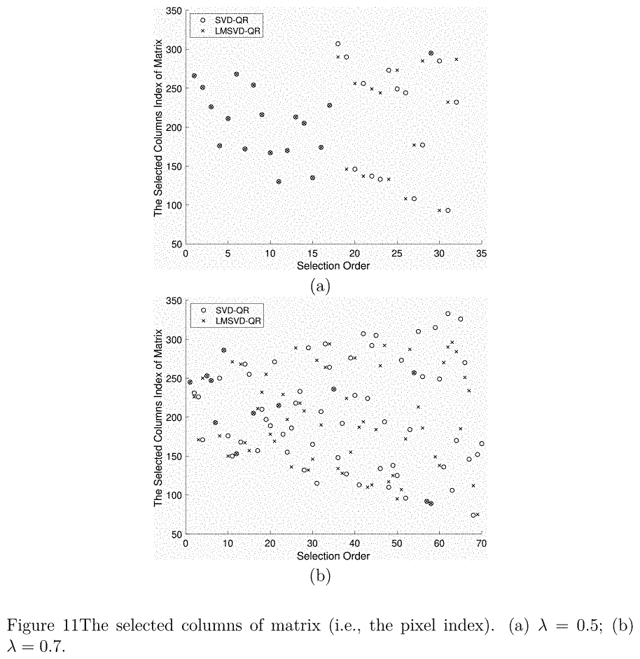

To look into whether SVD-QR and LMSVD preprocessing algorithms kept the same pixels, we scattered the kept 32 pixels for SVD-QR and LMSVD-QR when λ=0.5 and the kept 70 pixels for λ=0.7 in FIGS. 11a and 11b, respectively. Observe these two figures, the kept pixels are not the same, which means, SVD-QR and LMSVD-QR could achieve good performance with different outcomes. Since SVD and LMSVD result in different singular values and singular vectors, the QR will have different selected pixels. SVD-QR is for large-scale data input, but for mass data input, LMSVD-QR is more appropriate to be used to increase the processing speed.

### BIBLIOGRAPHY

[1] http://www.deeplearningbook.org 10

[2] R. Baranuik, “Compressive sensing,” IEEE Signal Processing Magazine, Vol. 24, No. 4, pp. 118-121, July 2007. 2

[3] E. Candés, “Compressive sampling,” Int. Congress of Mathematics, vol. 3, pp. 1433-1452, Madrid, Spain, 2006. 2

[4] E. Candés and J. Romberg, “Sparse and incoherence in compressive sampling,” Inverse Problem, vol. 23, no. 3, pp. 969-985, 2007. 2

[5] E. Candés and M. Wakin, “An introduction to compressive sampling,” IEEE Signal Processing Magazine, vol. 25, no. 2, pp. 21-30, March 2008. 2

[6] D. Donoho “Compressed sensing,” IEEE Trans. on Information Theory, Vol. 52, No. 4, pp. 1289-1306, April 2006. 2

[7] G. H. Golub and C. F. Van Loan, Matrix Computation, John Hopkins University Press, Baltimore, ML, 2013. 7

[8] T. Hastie, R. Tibshirani, and J. Friedman, The Elements of Statistical Learning, 2nd Ed, Springer, New York, N.Y., 2008. 10

[9] A. Krizhevsky, I. Sutskever, and G. E. Hinton, “ImageNet classification with deep convolutional neural networks,” NIPS 2012: Neural Information Processing Systems, Lake Tahoe, Nev. 1

[10] X. Liu, Z. Wen, and Y. Zhang, “Limited memory block Krylov subspace optimization for computing dominant singular value decompositions,” SIAM Journal on Scientific Computing, vol. 35, no. 3, pp. 1641-1668, 2013. 8, 9

[11] National Research Council, Frontiers in Massive Data Analysis, Washington, D.C.: The National Academies Press, https://doi.org/10.17226/18374, 2013. 3

[12] A. Ng, Machine Learning, www.coursera.org 9, 10, 11

[13] P. P. Vaidyanathan and P. Pal, “Sparse sensing with co-prime samplers and arrays,” IEEE Transactions on Signal Processing, vol. 59, No. 2, February 2011, pp. 573-586. 2

[14] P. P. Vaidyanathan and P. Pal, “Theory of sparse coprime sensing in multiple dimensions”, IEEE Trans. on Signal Processing, vol. 59, no. 8, August 2011, pp. 3592-3608. 2

What is claimed:

1. A method for smart and fast data pre-processing in deep learning comprises two approaches for different application scenarios.

2. The method of claim 1, wherein said different application scenarios comprising large scale data input and mass data input.

3. The method of claim 1, wherein said two approaches comprising SVD-QR and LMSVD-QR.

4. The method of claim 3, wherein said SVD-QR is used for the said large scale data input in claim 2.

5. The method of claim 3, wherein said LMSVD-QR is used for the said mass data input in claim 2.

6. A computer-readable medium carrying one or more sequences of one or more instructions for input data pre-processing in deep learning, the one or more sequences of one or more instructions including instructions which, when executed by one or more processors, cause the one or more processors to perform the steps recited in any one of claims 1-5.

7. An application system configured to include data pre-processor to perform the steps recited in any one of claims 1-5, as input to deep learning comprising: a device configured to compute the singular values using the said SVD or LMSVD; said device configured to determine the number of singular values to select; said device configured to perform the said QR computation to determine which columns in weight matrix should be selected.
